(19) United States
(12) Patent Application Publication
(10) Pub. No.: US 2017/0058069 A1
(43) Pub. Date: Mar. 2, 2017

(54) A Photocurable Sealing Agent Composition, Its Preparation and Its Use

(71) Applicant: HUNTSMAN ADVANCED MATERIALS (SWITZERLAND) GMBH, Basel (CH)

(72) Inventors: Riichiro Maruta, Yokkaichi-city (JP); Naoki Mori, Chiba (JP)

(21) Appl. No.: 15/307,879

(22) PCT Filed: Apr. 16, 2015
(86) PCT No.: PCT/EP2015/058285

§ 371 Date: Oct. 31, 2016

(30) Foreign Application Priority Data
May 6, 2014 (EP) 14167238.6

(51) Int. Cl. C08F 290/06

(52) U.S. Cl. CPC C08F 290/067

(57) ABSTRACT

An active energy ray-curable sealing agent composition, comprising (A) at least one unsaturated group-containing urethane oligomer having a number average molecular weight Mₙ of from 1,000 to 100,000 and a degree of unsaturation of from 0.1 to 1 mol/kg obtained by reacting at least one hydrogenated diene-based oligomer diol (a) having a number average molecular weight Mₙ of from 500 to 3,000, at least one bifunctional epoxy (meth)acrylate (b) containing two hydroxyl groups and two ethylenically unsaturated groups in the molecule thereof, and at least one polyisocyanate (c); (B) at least one (meth)acrylic ester monomer obtained by esterification of (meth)acrylic acid or a (meth)acrylic acid derivative with an alcohol of the formula R—OH, wherein R corresponds to an organic radical containing 1 to 20 carbon atoms and having a molecular weight of 1,000 or less; and (C) at least one photopolymerization initiator; exhibits an improved curability and is suitable for the preparation of gaskets exhibiting low hardness, enhanced flexibility and elongation, enhanced durability, and very low moisture vapor transmission rate for encasing high precision electronic instruments.

The present invention relates to an active ray-curable sealing agent composition, its preparation, and a body housing provided with a sealing layer comprised of a cured product of the active ray-curable sealing agent composition. The active ray-curable sealing agent composition according to the present invention is suitable as a gasket for sealing body housings which encase high precision electronic instruments, such as an electronic circuit unit or a magnetic hard disc drive apparatus (HDD), which are used, for example, as an electronic control device in an automobile, or as a memory device in a computer.

A sealing agent or a gasket has hitherto been used for sealing body housings encasing high precision electronic devices from interference caused by penetration of dust and humidity.

In order to further reduce plant investment and processing expenses, gaskets are nowadays most widely prepared by applying to body housings an active ray-curable sealing agent composition by means of a dispenser or similar equipment, and then irradiating the sealing agent composition applied with ultraviolet ray. In many cases, active ray-curable sealing agent compositions providing the sealibility required for the use as a gasket to protect high precision electronic instruments contain a urethane acrylate oligomer having a low hardness and a high flexibility such as described, for example, in WO96/10594.

Urethane acrylate oligomers are obtained by chemically bonding together a polyol, such as a polyester polyol, a polyether polyol or a polycarbonate polyol, a diisocyanate, and a hydroxyl group-containing monomer having radically polymerizable unsaturated groups.

In the case of a urethane acrylate oligomer used as a component of an active energy ray-curable sealing agent composition, the molecular weight of said urethane acrylate oligomer must be high enough to obtain the required properties, such as a low hardness, an enhanced flexibility and elongation. However, the portion of terminal hydroxyl groups in the oligomer is decreasing with increasing molecular weight, i.e. the portion of terminal hydroxyl groups is lower for high molecular weight oligomers compared to low molecular weight oligomers. Along with the portion of the hydroxyl groups also the portion of the radically polymerizable unsaturated groups is decreasing with increasing molecular weight. Unfortunately, the curing properties, i.e. the curing rate, of the sealing agent composition are deteriorated and undercure due to insufficient crosslinking density is likely to occur in the case of a high molecular weight urethane acrylate oligomers. The deterioration in curing properties is likely to cause a decrease of performance properties such as physical and mechanical strength and durability.

In view of the foregoing disadvantages, it is an object of the present invention to provide an active energy ray-curable sealing agent composition exhibiting an improved curability performance for the preparation of gaskets with the required sealing properties for protecting high precision electronic instruments from the environment. The cured composition shall exhibit a low hardness, an enhanced flexibility and elongation along with improved physical and mechanical strength, enhanced durability, and a very low moisture vapor transmission rate.

It is another object of the present invention to provide the urethane acrylate oligomers used as a component of the active energy ray-curable sealing agent composition above.

Yet another object of the present invention is directed to a process for the preparation of a gasket by using the above composition. The process according to the present invention allows for the preparation of a gasket in an accurate shape, enables easy operations of forming and attaching the gasket without requiring much labor. The loss of the used material is reduced by the process according to present invention.

Still another object of the present invention is to provide a unit, such as a body housing, comprising a gasket obtained according to the process above which exhibits the required sealing properties for protecting high precision electronic instruments.

The present inventors made extensive research for solving the above-mentioned problems, and found that an active energy ray-curable sealing agent composition is suitable for the preparation of gaskets, said composition comprising

(A) at least one unsaturated group-containing urethane oligomer having a number average molecular weight Mₙ of from 1,000 to 100,000 and a degree of unsaturation of from 0.1 to 1 mol/kg obtained by reacting

at least one hydrogenated diene-based oligomer diol (a) having a number average molecular weight Mₙ of from 500 to 3,000,

at least one bifunctional epoxy (meth)acrylate (b) containing two hydroxyl groups and two ethylenically unsaturated groups in the molecule thereof, and

at least one polyisocyanate (c);

(B) at least one (meth)acrylic ester monomer obtained by esterification of (meth)acrylic acid or a (meth)acrylic acid derivative with an alcohol of the formula R—OH, wherein R corresponds to an organic radical containing 1 to 20 carbon atoms and having a molecular weight of 1,000 or less; and

(C) at least one photopolymerization initiator.

The active energy ray-curable sealing agent composition according to the present invention exhibits an improved curability performance upon irradiation with active energy ray and is suitable for the preparation of gaskets for sealing body housings encasing high precision electronic instruments. The cured composition exhibits a low hardness, an enhanced flexibility and elongation along with improved physical and mechanical strength, enhanced durability, and a very low moisture vapor transmission rate.

### BRIEF DESCRIPTION OF THE DRAWINGS

FIG. 1 is an elevational view illustrating an example of an apparatus for ejecting and shaping the active energy ray-curable sealing agent composition according to the present invention.

FIG. 2 is a plan view of a protective cover of a container provided with a sealing layer, such as a dust cover.

FIG. 3 is a diagrammatical elevational view illustrating an apparatus for evaluating airtight sealability.

### EXPLANATION OF REFERENCE NUMERALS

1: X-Y-Z drive robot control device
2: Curable composition supply tube
3: Dispenser
4: Metal sheet
5: Gasket
6: Airtight sealbility-testing base
7: Supply tube
8: Water-gauge pressure manometer

The invention is described in more detail below:

The at least one hydrogenated diene-based oligomer diol (a) having a number average molecular weight Mₙ of from 500-3,000 is hereinafter referred to as “diol (a)”.

The at least one bifunctional epoxy (meth)acrylate (b) containing two hydroxyl groups and two ethylenically unsaturated groups is a bifunctional epoxy acrylate or a bifunctional epoxy methacrylate, said bifunctional epoxy acrylate or methacrylate is hereinafter referred to “(meth)acrylate (b)”.

The hydrogenated diene-based oligomer diol (a) is, for example, a hydrogenated oligomer with terminal hydroxyl groups or a mixture of at least two hydrogenated oligomers with terminal hydroxyl groups. Examples of such oligomers comprise homopolymeric or copolymeric oligomers prepared from, for example, at least one compound selected from the group 1,3-butadiene, isoprene, 2,3-dimethyl-1,3-butadiene, 1,3-pentadiene (piperylene), 2-methyl-3-ethyl-1,3-butadiene, 3-methyl-1,3-pentadiene, 1,3-hexadiene, 2-methyl-1,3-hexadiene and 3-buthyl-1,3-octadiene. Homopolymeric or copolymeric oligomers prepared from at least one compound selected from the group 1,3-butadiene and polyisoprene are preferred.

The bifunctional epoxy acrylate or methacrylate (b) having two hydroxyl groups and two ethylenically unsaturated groups in the molecule include, for example, a bifunctional epoxy acrylate represented by the following formula (b-1)

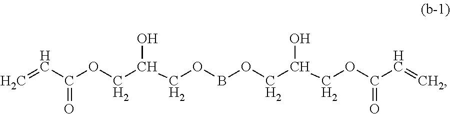

and a bifunctional epoxy methacrylate of formula (b-2)

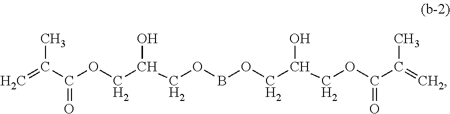

wherein

B independently is an aliphatic or aromatic bridge member.

An aliphatic bridge member B is, for example, a C₂-C₁₂alkylene radical, in particular a C₂-C₈alkylene radical, such as 1,2-ethylene, 1,3-propylene, 1,2-propylene, 1,4-butylene, 1,5-pentylene, 1,6-hexylene, 1,7-heptylene, and 1,8-octylene.

Aliphatic bridge members B are furthermore, for example, C₅-C₉cycloalkylene radicals, such as, in particular, cyclohexylene radicals. The cycloalkylene radicals mentioned can be unsubstituted or substituted, for example, by C₁-C₄alkyl. Aliphatic bridge members B are furthermore methylene-cyclohexylene, ethylene-cyclohexylene, methylene-cyclohexylene-methylene, cyclohexylene-methylene-cyclohexylene, cyclohexylene-ethylene-cyclohexylene or cyclohexylene-propylene-cyclohexylene radicals which are unsubstituted or substituted in the cyclohexylene ring by C₁-C₄alkyl. Propylene in the bridge member B in the meaning of cyclohexylene-propylene-cyclohexylene is, for example, 2,2-propylene.

An aromatic bridge member B is, for example, C₁-C₆alkylene-phenylene, for example methylene-phenylene, C₁-C₄alkylene-phenylene-C₁-C₄alkylene, for example methylene-phenylene-methylene, or phenylene which are unsubstituted or substituted by C₁-C₄alkyl, or a radical of the formula

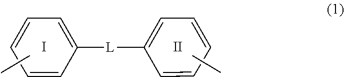

in which the benzene rings I and II are unsubstituted or substituted, for example, by C₁-C₄alkyl, and L is the direct bond or a C₁-C₃alkylene radical, for example, methylene or 2,2-propylene, or L is a radical of formula —CO— or —SO₂—.

The above mentioned substituents C₁-C₄alkyl are, for example, methyl and ethyl, preferably methyl.

B is preferably a C₂-C₁₂alkylene radical, in particular a C₂-C₈alkylene radical, and especially a C₂-C₆alkylene radical.

Acrylate and methacrylate are hereinafter generically referred to as “(meth)acrylate”, and acrylic acid and methacrylic acid are hereinafter generically referred to as “(meth)acrylic acid”.

As specific examples of the bifunctional epoxy (meth)acrylates of the formula (b-1) or (b-2), there may be mentioned an addition product of acrylic acid or methacrylic acid to propylene glycol diglycidyl ether, an addition product of (meth)acrylic acid to 1,6-hexanediol diglycidyl ether, an addition product of (meth)acrylic acid to ethylene glycol diglycidyl ether, an addition product of (meth)acrylic acid to 1,4-butanediol diglycidyl ether, an addition product of (meth)acrylic acid to 1,5-pentanediol diglycidyl ether, an addition product of (meth)acrylic acid to 1,7-heptanediol diglycidyl ether, an addition product of (meth)acrylic acid to 1,8-octanediol diglycidyl ether, an addition product of (meth)acrylic acid to neopentyl glycol diglycidyl ether, an addition product of (meth)acrylic acid to bisphenol-A diglycidyl ether and an addition product of (meth)acrylic acid to hydrated bisphenol-A diglycidyl ether. Of these, an addition product of (meth)acrylic acid to propylene glycol diglycidyl ether and an addition product of (meth)acrylic acid to 1,6-hexanediol diglycidyl ether are preferred.

The ingredient (b) may be used either alone or as a combination of at least two thereof.

The polyisocyanate (c) is not particularly limited and preferably includes, for example, diisocyanate compounds such as aliphatic diisocyanate compounds, alicyclic disocyanate compounds and aromatic diisocyanate compounds.

As specific examples of the diisocyanate compounds, there may be mentioned tolylene diisocyanate, 4,4-diphenylmethane diisocyanate, xylylene diisocyanate, xylene diisocyanate, hexamethylene diisocyanate, lysine diisocyanate, 4,4′-methylenebis(cyclohexyl isocyanate), methylcyclohexane-2,4-diisocyanate, methylcyclohexane-2,6-diisocyanate, 1,3-(isocyanate methyl)cyclohexane, isophorone diisocyanate, trimethylhexamethylene diisocyanate, dimer acid diisocyanate, dianisidine diisocyanate, phenyl diisocyanate, halogenated phenyl diisocyanate, methylene diisocyanate, ethylene diisocyanate, butylene diisocyanate, propylene diisocyanate, octadecylene diisocyanate, 1,5-naphthalene diisocyanate, polymethylene polyphenylene diisocyanate, triphenylmethane triisocyanate, tolylene diisocyanate polymer, diphenylmethane diisocyanate polymer, hexamethylene diisocyanate polymer, 3-phenyl-2-ethylene diisocyanate, cumene-2,4-diisocyanate, 4-methoxy-1,3-phenylene diisocyanate, 4-ethoxy-1,3-phenylene diisocyanate, 2,4′-diisocyanate diphenyl ether, 5,6-dimethyl-1,3-phenylene diisocyanate, 4,4′-diisocyanate diphenyl ether, benzidine diisocyanate, 9,10-anthracene diisocyanate, 4,4′-diisocyanate benzyl, 3,3′-dimethyl-4,4′-diisocyanate diphenylmethane, 2,6′-dimethyl-4,4′-diisocyanate diphenyl, 3,3′-dimethoxy-4,4′-diisocyanate diphenyl, 1,4-anthracene diisocyanate, phenylene diisocyanate, 2,4,6-tolylene triisocyanate, 2,4,4′-triisocyanate diphenyl ether, 1,4-tetramethylene diisocyanate, 1,6-hexamethylene diisocyanate, 1,10-decamethylene diisocyanate, 1,3-cyclohexylene diisocyanate and 4,4′-methylene-bis(cyclohexyl isocyanate).

In addition to the diisocyanate compounds, the polyisocyanate (c) may further include, for example, polyisocyanate compounds having at least three isocyanate group such as triphenylmethane-4,4′,4″-triisocyanate, 1,3,5-triisocyanatobenzene, 2,4,6-triisocyanato-toluene and 4,4′-dimethyldiphenylmethane-2,2′,5,5′-tetraisocyanate; addition products prepared by reacting a polyisocyanate compound with a polyol such as ethylene glycol, propylene glycol, 1,4-butylene glycol, polyalkylene glycol, trimethylolpropane and hexanetriol, at a ratio such that the isocyanate groups in the polyisocyanate compound are in excess to the hydroxyl groups in the polyol; buret type adducts such as hexamethylene diisocyanate, isophorone diisocyanate, tolylene diisocyanate, xylylene diisocyanate, 4,4′-diphenylmethane diisocyanate and 4,4′-methylenebis(cyclohexyl isocyanate); and isocyanuric ring-type adducts.

The polyisocyanate ingredients (c) may be used either alone or as a combination of at least two thereof.

The unsaturated group-containing urethane resin (A) is obtained by reaction of the polyisocyanate (c) with the hydrogenated diene-based oligomer diol (a) and the bifunctional epoxy acrylate and/or bifunctional epoxy methacrylate (b) having two hydroxyl groups and two ethylenically unsaturated groups in each molecule. The unsaturated group-containing urethane resin (A) provides a cured sealing agent composition exhibiting the properties indicated above. The enhanced curability, good physical and mechanical strengths and enhanced durability are attributed to the bifunctional epoxy (meth)acrylate (b). The low hardness, enhanced flexibility and elongation are attributed to diol (a).

If the polyisocyanate (c) is reacted only with the bifunctional epoxy (meth)acrylate (b), the resulting unsaturated group-containing urethane resin has a high degree of unsaturation and exhibits a high curability, but, the resulting cured sealing agent composition has high hardness and insufficient flexibility and elongation, and its performance in sealing quality is not satisfactory.

If the polyisocyanate (c) is reacted only with the diol (a), the resulting urethane resin does not have unsaturated bonds, and therefore, it is difficult to cure the urethane resin by irradiation with active energy rays.

If diols other than the diol (a) is used, or, if an epoxy (meth)acrylate other than the bifunctional epoxy (meth)acrylate (b) is used, the resulting urethane resin tends to have poor curability, and provides a cured sealing agent composition having a poor performance in sealing quality.

The unsaturated group-containing urethane oligomer (A) has a number average molecular weight Mn of from 1,000 to 100,000, preferably of from 10,000 to 50,000 and a degree of unsaturation of from 0.1 to 1 mol/kg, preferably of from 0.1 to 0.5 mol/kg. If the urethane resin (A) has a number average molecular weight lower than the above range, the cured sealing agent composition tends to have undesirably high hardness, and poor flexibility and elongation. In contrast, if the urethane resin (A) has a number average molecular weight higher than the above range, the crystallizability and viscosity of the urethane resin are undesirably high and the production stability is often poor. If the urethane resin (A) has a degree of unsaturation lower than the above range, the curing properties of the curable sealing agent composition is insufficient, the cured film exhibits a low crosslinking density, and the cured sealing agent composition tends to have poor physical and mechanical strength and poor durability. In contrast, if the urethane resin (A) has a degree of unsaturation higher than the above range, the cured sealing agent composition tends to have undesirably high hardness, and poor flexibility and elongation, although the curing properties are sufficient.

In the present invention, the number average molecular weight Mₙ of the unsaturated group-containing urethane oligomer (A) and the number average molecular weight Mₙ of the hydrogenated diene-based oligomer diol (a) used to prepare the urethane oligomer (A) are determined by the gel permeation chromatography using polystyrene having a known molecular weight as the reference material.

The term “degree of unsaturation” as used herein, means the value expressed by the product of “α×β” wherein a is the amount of the bifunctional epoxy (meth)acrylate (b) in mole required for the production of 1 kg of the unsaturated group-containing urethane resin (A), and β is the number of radically polymerizable unsaturated bonds contained in one molecule of the bifunctional epoxy (meth)acrylate (b).

The above unsaturated group-containing urethane resin (A) is novel. Accordingly, the present invention is also directed to an unsaturated group-containing urethane resin (A) having a number average molecular weight Mₙ of from 1,000 to 100,000 and a degree of unsaturation of from 0.1 to 1 mol/kg obtained by reacting at least one hydrogenated diene-based oligomer diol (a) having a number average molecular weight Mₙ of from 500 to 3,000, at least one bifunctional epoxy (meth)acrylate (b) containing two hydroxyl groups and two ethylenically unsaturated groups in the molecule thereof, and at least one polyisocyanate (c), wherein the oligomer diol (a), the bifunctional epoxy(meth)acrylate (b) and the polyisocyanate (c) are defined and preferred as given above.

The above unsaturated group-containing urethane resin (A) can be prepared by reacting the above mentioned oligomer diol (a), the bifunctional epoxy(meth)acrylate (b) and the polyisocyanate (c) with each other. The reaction can be carried out in the presence or in the absence of a solvent. As the solvent suitably an organic solvent is used. The organic solvent includes chemically inactive solvents which are, for example, selected from hydrocarbons, ketones, ethers and esters. After completion of the reaction, the organic solvent used is removed from the produced unsaturated group-containing urethane resin by, for example, distillation under reduced pressure.

The (meth)acrylic ester monomer (B) can be used as a solvent for the reaction of oligomer diol (a), bifunctional epoxy(meth)acrylate (b) and polyisocyanate (c). But (meth)acrylic acid monomers having a hydroxyl group in the molecule generally are not suitable for use as a solvent, because the hydroxyl group will react with the polyisocyanate (c).

The reaction temperature is appropriately in the range of 20 to 250° C., preferably 50 to 150° C. Appropriately, the reaction is carried out until the isocyanate residue disappears. The reaction time is usually in the range of 10 minutes to 48 hours. The reaction may be carried out in the absence of a catalyst. However, if desired, a catalyst for promoting the reaction of an isocyanate group with a hydroxyl group can be used. Conventional catalysts may be used, but, amine compounds and organic zinc compounds are preferred, because these compounds do not give substantial adverse effect on operation of magnetic hard disc drive apparatuses. As specific examples of the amine compound, there may be mentioned triethylamine, dimethylcyclohexylamine, tetramethylethylenediamine, pentamethyl-dipropylenediamine, tetramethylguanidine, triethylenediamine, N-methyl-morpholine, 1,2-dimethylimidazole, dimethylaminoethanol, dimethylaminoethoxyethanol, triethylaminoethyl-ethanolamine, (2-hydroxyethyl)morpholine-etheramine, N-methyl-piperazine, N,N′-dimethylpiperazine and N-endoethylenepiperazine. As specific examples of the organic zinc compound, there may be mentioned zinc-2-ethylcaproate, zinc octenoate, zinc octylate and zinc naphthenate. Appropriately, the catalyst is used in an amount of from 0.005 to 0.5 part by weight based on 100 parts by weight of the total of oligomer diol (a), bifunctional epoxy(meth)acrylate (b) and polyisocyanate (c).

In the process of reacting the components (a), (b) and (c), a polymerization inhibitor can be added in an appropriate amount for preventing or minimizing polymerization of the unsaturated group and the (meth)acrylic ester monomer.

The amounts of the components (a), (b) and (c) applied for the preparation of the unsaturated group-containing urethane resin (A) can be varied within the limits required to adjust the degree of unsaturation and the number average molecular weight indicated above. Preferably, the amount of (a) is 60 to 90% by weight, the amount of (b) is 2.5 to 15% by weight, and the amount of (c) is 5 to 25% by weight, each based on the total weight of the ingredients (a), (b) and (c).

The (meth)acylic ester monomer (B) is susceptible to radical polymerization and contains an alcohol residue R—OH linked via an ester bond to the (meth)acryloyl group. R corresponds to an organic radical containing 1 to 20 carbon atoms and having a molecular weight of 1,000 or less. Preferred is a monofunctional (meth)acrylic acid ester monomer having one (meth)acryloyl group.

As specific examples of the monofunctional (meth)acrylic ester monomer, there may be mentioned chainlike (meth)acrylates such as methyl (meth)acrylate, ethyl (meth)acrylate, n-propyl (meth)acrylate, isopropyl (meth)acrylate, n-butyl (meth) acrylate, hexyl (meth)acrylate, 2-ethylhexyl (meth)acrylate, 1-ethylheptyl (meth)acrylate, nonyl (meth)acrylate, isononyl (meth)acrylate, 1-butylamyl (meth)acrylate, lauryl (meth)acrylate and octadecyl (meth) acrylate; (meth)acrylates having a cyclic structure such as isobornyl (meth)acrylate, cyclohexyl (meth)acrylate, tetrahydrofurfuryl (meth)acrylate, phenoxy (meth)acrylate, phenoxyethyl (meth)acrylate, 2-hydroxy-3-phenoxypropyl (meth)acrylate, alkylphenoxy (meth)acrylates, alkylphenoxyethyl (meth)acrylates, dicyclopentenyl (meth)acrylate, dicyclopentanyl (meth)acrylate, phenoxydiethylene glycol (meth)acrylate and nonylphenoxypolyethylene glycol (meth) acrylate; hydroxyalkyl (meth) acrylates such as hydroxymethyl (meth)acrylate, 2-hydroxyethyl (meth)acrylate, 2-hydroxypropyl (meth)acrylate, 3-hydroxypropyl (meth)acrylate, 2-hydroxy-butyl (meth)acrylate, 4-hydroxybutyl (meth)acrylate, 6-hydroxyhexyl (meth)acrylate, 8-hydroxyoctyl (meth) acrylate and 2-hydroxylauryl (meth)acrylate; and oligo- and poly-oxyalkylene glycol mono (meth)acrylates such as diethylene glycol mono (meth)acrylate, triethylene glycol mono (meth)acrylate, polyethylene glycol mono (meth)acrylate, dipropylene glycol mono (meth)acrylate, trimethylene glycol mono (meth)acrylate and polypropylene glycol mono (meth)acrylate.

Of these monofunctional (meth)acrylic acid ester monomers, phenoxyethyl (meth)acrylate, 2-hydroxy-3-phenoxypropyl (meth)acrylate, tetrahydrofurfuryl (meth)acrylate, phenoxydiethylene glycol (meth)acrylate, nonyl (meth)acrylate, isobornyl (meth)acrylate, nonylphenoxypolyethylene glycol (meth)acrylate, cyclohexyl (meth)acrylate and dicyclopentanyl (meth)acrylate are preferred.

The (meth)acrylic ester monomers may be used either alone or as a combination of at least two thereof.

A photopolymerization initiator useful as component (C) generates a radical upon irradiation with light, which radical initiates the radical polymerization of the unsaturated group-containing urethane resin (A) and the (meth)acrylic acid ester monomer (B). As long as this function is provided, no particular limitation is imposed, and conventional photopolymerization initiators can be used.

As specific examples of the photopolymerization initiator, there may be mentioned benzoin, benzoin methyl ether, benzoin ethyl ether, benzoin isobutyl ether, diethoxyacetophenone, 2-hydroxy-2-methyl-1-phenylpropan-1-one, benzyldimethylketal, 1-hydroxycyclohexyl-phenyl ketone, 2-methyl-2-morpholino-(4-thiomethylphenyl)propan-1-one, 2-benzyl-2-dimethylamino-1-(4-morpholinophenyl)butanone, 2,4,6-trimethylbenzoyldiphenylphosphine oxide, 2,4,6-trimethylbenzoylphenyl-ethoxyphosphine oxide, benzophenone, methyl o-benzoylbenzoate, hydroxybenzophenone, 2-isopropylthioxanthone, 2,4-dimethylthioxanthone, 2,4-diethyl-thioxanthone, 2,4-dichlorothioxanthone, 2,4,6-tris(trichloromethyl)-s-triazine, 2-methyl-4,6-bis(trichloromethyl)-s-triazine, 2-(4-methoxyphenyl)-4,6-bis(trichloromethyl)-s-triazine, ironarene complexes, and titanocene compounds.

These photopolymerization initiators may be used either alone or as a combination of at least two thereof.

The active energy ray-curable sealing agent composition comprises, for example, 10 to 90% by weight of unsaturated group-containing urethane oligomer (A), 10 to 90% by weight of the (meth)acrylic acid ester monomer (B), and 0.1 to 10% by weight of the photopolymerization initiator based on the total weight of the components (A), (B) and (C) in the composition.

When the amount of the unsaturated group-containing urethane oligomer (A) in the composition is larger than 90% by weight based on the total weight of the components (A), (B) and (C), the viscosity of the composition becomes excessively high, resulting in poor application properties, for example, when applied by a dispenser or other applicators. In contrast, when the amount of the unsaturated group-containing urethane resin (A) is smaller than 10% by weight based on the total weight of the components (A), (B) and (C) in the composition, the cured sealing composition tends to exhibit undesirably high hardness, and poor flexibility and elongation. Likewise, the cured sealing agent composition tends to exhibit undesirably high hardness, and poor flexibility and elongation, when the amount of the (meth)acrylic acid ester monomer (B) is larger than 90% by weight based on the total weight of the components (A), (B) and (C). In contrast, when the amount of the (meth)acrylic acid ester monomer (B) is smaller than 10% by weight based on the total weight of the components (A), (B) and (C), the viscosity of the composition becomes excessively high, resulting in poor application properties, for example, when applied by a dispenser or other applicators. When the amount of the photopolymerization initiator (C) is larger than 10% by weight based on the total weight of the components (A), (B) and (C), the storage stability of the composition becomes poor, resulting in poor physical properties of the cured sealing agent composition, and outgassing occurs to adversely affect precision electronic parts and devices such as a magnetic hard disc drives. In contrast, when the amount of the photopolymerization initiator (C) is smaller than 0.1% by weight based on the total weight of the components (A), (B) and (C), the curability of the composition by active energy ray irradiation is poor.

If desired, a filler (D) can be incorporated in the sealing agent composition of the present invention. As the filler (D), inorganic fillers and organic fillers which are conventionally used for most curable resin compositions can be used. The filler is preferably in a fine particle form. The inorganic filler includes, for example, silica, finely divided quartz, calcium carbonate, mica, talc, titanium dioxide, aluminum silicate, calcium metasilicate, calcium sulfate, barium sulfate, zinc oxide and glass fiber. The organic filler includes fine particles of synthetic resins such as, for example, an acrylic resin, a styrene resin, a phenolic resin, a silicone resin and an urethane resin. The fine filler particles preferably have an average primary particle diameter in the range of 1 nm to 20 μm. The filler may be used either alone or as a combination of at least two fillers. Appropriately, the filler is added in an amount of 0.1 to 10 parts by weight based on 100 parts of the total weight of the ingredients (A), (B) and (C).

Appropriately, additives such as a polymerization inhibitor, a heat stabilizer, a light stabilizer, an antioxidant, an adhesion-imparting agent, a dispersion aid, a leveling agent, a pigment, a dye, a thermal polymerization initiator and a plasticizer may be used provided that the effect of the invention is not adversely affected.

The process for preparing the active energy ray-curable sealing agent composition of the present invention is not particularly limited, and conventional processes can be applied. For example, the sealing agent composition can be prepared by kneading together the above-mentioned components (A), (B) and (C), or the components (A), (B), (C) and (D), plus optional ingredients, by using a temperature-controllable kneading or mixing apparatus such as, for example, a single screw extruder, a twin screw extruder, a planetary mixer, a biaxial extruder, a biaxial mixer and a high shear mixer.

If the (meth)acrylic acid ester monomer (B) is used as a solvent for the preparation of the unsaturated group-containing urethane oligomer, the reaction mixture can be used as it is as a mixture of the components (A), (B) and (C).

Active energy rays used for curing the active energy ray-curable sealing agent composition of the present invention are not particularly limited, and comprise, for example, ultraviolet rays, visible light, and lasers including near infrared rays, visible light laser and ultraviolet ray laser. The irradiation dose is usually in the range of from 0.2 to 15,000 mJ/cm², preferably in the range of from 1 to 10,000 mJ/cm².

The unit provided with a sealing layer such as a body housing encasing a magnetic hard disc drive apparatus or an electronic control device in an automobile, is prepared by applying to the unit the active energy ray-curable sealing agent composition of the present invention, and then, irradiating the thus-applied sealing agent composition with active energy rays thereby curing the sealing agent composition. The application of the sealing agent composition to the unit can be carried out by conventional procedures.

Advantageously, the sealing agent compositions according to the present invention can be rapidly cured without long curing periods being required and it takes only, for example, several seconds to cure. These instant cure characteristics allow for higher productivity in commercial production to be achieved.

The following Examples serve to illustrate the invention. Unless otherwise indicated, the temperatures are given in degrees Celsius, parts are parts by weight and percentages relate to % by weight. Parts by weight relate to parts by volume in a ratio of kilograms to litres.

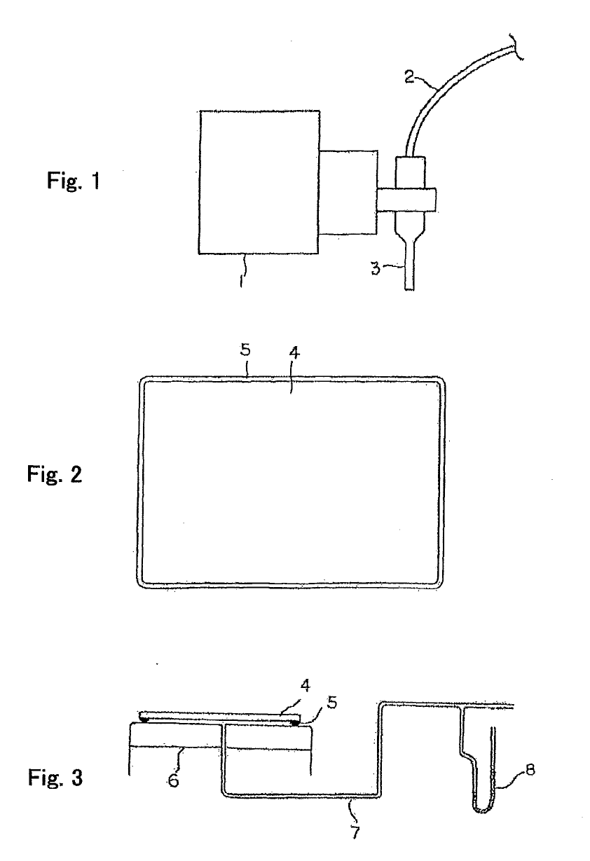

The preparation of the curable sealing agent compositions according to the present invention is described in more detail in Examples 1 to 8. Curable compositions according to the prior art are prepared according to Comparative Examples 1 to 6. The properties of the curable and cured compositions are determined by the following test methods (1) to (7). The test results are shown in Table 1. Specimens of the cured compositions used for test methods (2) to (5) are prepared by spreading the curable compositions obtained according to Examples 1 to 8 and Comparative Examples 1 to 6 on a quartz glass sheet equipped with a spacer of 2 mm thickness. The uncured composition applied to the quartz sheet is covered with another quartz sheet and irradiated with ultraviolet rays at a dose of 2,000 mJ/cm² to yield a sheet of the cured composition. Specimens for evaluating cured compositions according to test methods (6) and (7) are obtained by preparing a gasket close to the edge of a degreased metal sheet 4 sized 102 mm×146 mm which is used as a dust cover for encasing magnetic hard disc drives. Preparation of the gasket 5 onto the metal sheet 4 is carried out by application of the curable composition through a supply tube 2 and a dispenser 3 using a robot applicator provided with an X-Y-Z drive robot control device 1 as illustrated in FIG. 1. The composition for gasket thus applied is irradiated with ultraviolet rays at a dose of 2,000 mJ/cm² to give a dust cover with the gasket 5 of the cured composition as illustrated in FIG. 2.

(1) Reactivity

The compositions according to the present invention (Examples 1 to 8) and the prior art (Comparative Examples 1 to 6) are separately applied on a quartz glass sheet by using an applicator and a coating of each composition is obtained having a thickness of approximately 100 μm. Then each composition applied is irradiated with ultraviolet rays at a dose of 2,000 mJ/cm². The curing properties (Reactivity) of the specimens are examined by tactile comparison of their surfaces. The property of each specimen is given in accordance with the following three ratings:

Acceptable (A): no tack

Medium (M): slight tack

Unacceptable (U): considerable tack.

(2) Hardness

Shore hardness A is measured according to JIS K 6253. The evaluation results are given in accordance with the following two ratings:

Acceptable (A): Shore A hardness is 15 to 45

Unacceptable (U): Shore A hardness is larger than 45

A Shore hardness A in the range of 15 to 45 is acceptable for a cured sealing agent composition.

(3) Elongation

Elongation is measured according to JIS K 6251. The evaluation results are given in accordance with the following two ratings:

Acceptable (A): elongation of at least 200%

Medium (M): elongation of from 100% to 200%

Unacceptable (U): elongation of 100% or lower.

The sealing agent properties improve with elongation of the cured composition, i.e. high elongation values translate into good sealing properties, whereas low elongation values translate into poor sealing properties.

(4) Tensile Strength

Tensile strength is measured according to JIS K 6251. The numerical values for tensile strength are shown in Table 1. The sealing agent properties improve with the tensile strength value of the cured composition increasing, i.e. high tensile strength values translate into good sealing properties (A), whereas low tensile strength values translate into poor sealing properties (U).

(5) Tear Strength

Tear strength is measured according to JIS K 6252. The numerical values for tensile strength are shown in Table 1. The sealing agent properties improve with the tear strength values of the cured composition increasing, i.e. high tear strength values translate into good sealing properties (A), whereas low tear strength values translate into poor sealing properties (U).

(6) Air Tightness

Air tightness of gaskets is evaluated by using a test apparatus as illustrated in FIG. 3, which is placed in a thermostatic chamber maintained at 25° C. A metal sheet 4 furnished on its periphery with a gasket 5 is fitted onto an airtight sealability-testing unit 6 by using a fixture (not shown) so that the gasket 5 is placed in contact with the upper surface of the testing base 6. Air is blown into a closed chamber between the lower surface of the metal sheet 4 and the upper surface of the base 6 through a supply tube 7. Air flow is discontinued when the pressure in the chamber reaches a water-gauge pressure of 30 mm. After ten minutes the chamber pressure is measured by means of a water-gauge pressure manometer 8. Air tightness is rated acceptable (A) when the pressure stays at 30 mm, whereas air tightness is rated unacceptable (U) when the pressure is reduced even moderately from water-gauge pressure of 30 mm.

(7) Durability

A metal sheet 4 furnished on the periphery of its upper side with a gasket 5 is aged for 500 hours at a temperature of 40° C. and a relative humidity of 90% in ambient pressure. Afterwards, the metal sheet together with the gasket is kept for one hour at 25° C. Then the air tightness is determined by the above-mentioned test method (6). Air tightness is rated as described above.

(8) Moisture Vapor Transmission (MVTR)

MVTR is measured according to JIS K 7129 with a film specimen of 2 mm thickness at a temperature of 40° C. and 90% RH condition. The numerical values for MVTR are shown in Table 1. The values are expressed in g/m² 24 hours in SI unit and correspond to the quantity of moisture permeated through the film specimen per m² of area in 24 hours. The evaluation results are given in accordance with the following two ratings:

Acceptable (A): MVTR is lower than 5 g/m² 24 h

Unacceptable (U): MVTR is higher than 5 g/m² 24 h.

High moisture vapour transmission rate values (higher than 5 g/m² 24 h) translate into poor sealing properties, whereas low moisture vapour transmission rate values (lower than 5 g/m² 24 h) translate into good sealing properties and indicate good moisture protection.

### Example 1

(i) 332 g of a hydrogenated butadiene oligomer diol (GI-1000® manufactured by Nippon Soda Co., Ltd, number average molecular weight: 1,500) as (a), 16 g of an acrylic acid adduct of 1,6-hexanediol diglycidyl ether (16HD(D)-DEXA® manufactured by Yokkaichi Chemical Company Ltd.) as (b), and 52 g of isophorone diisocyanate as (c) are placed into a 1-liter four-necked flask equipped with a thermometer, a condenser tube, and a stirrer.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of an unsaturated group-containing urethane acrylate oligomer (A) having a number average molecular weight Mₙ of 17,000 and a degree of unsaturation of 0.21 mol/kg, 47% by weight of acrylic ester monomers (B), and 3% by weight of a photopolymerization initiator (C), based on the total weight of the curable composition.

### Example 2

(i) 361 g of a hydrogenated butadiene oligomer diol (GI-1000® manufactured by Nippon Soda Co., Ltd, number average molecular weight: 1,500) as (a), 9 g of an acrylic acid adduct of 1,6-hexanediol diglycidyl ether (16HD(D)-DEXA® manufactured by Yokkaichi Chemical Company Ltd.) as (b), and 30 g of isophorone diisocyanate as (c) are placed into a 1-liter four-necked flask equipped with a thermometer, a condenser tube, and a stirrer.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of an unsaturated group-containing urethane acrylate oligomer (A) having a number average molecular weight Mₙ of 20,000 and a degree of unsaturation of 0.12 mol/kg, 47% by weight of acrylic ester monomers (B), and 3% by weight of a photopolymerization initiator (C), based on the total weight of the curable composition.

### Example 3

(i) 322 g of a hydrogenated butadiene oligomer diol (GI-2000® manufactured by Nippon Soda Co., Ltd, number average molecular weight: 2,000) as (a), 18 g of an acrylic acid adduct of 1,6-hexanediol diglycidyl ether (16HD(D)-DEXA® manufactured by Yokkaichi Chemical Company Ltd.) as (b), and 60 g of isophorone diisocyanate as (c) are placed into a 1-liter four-necked flask equipped with a thermometer, a condenser tube, and a stirrer.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of an unsaturated group-containing urethane acrylate oligomer (A) having a number average molecular weight Mₙ of 19,000 and a degree of unsaturation of 0.24 mol/kg, 47% by weight of acrylic ester monomers (B), and 3% by weight of a photopolymerization initiator (C), based on the total weight of the curable composition.

### Example 4

(i) 319 g of a hydrogenated isoprene oligomer diol (EPOL® manufactured by Idemitsu Kosan Co., Ltd, number average molecular weight: 2,500) as (a), 19 g of an acrylic acid adduct of 1,6-hexanediol diglycidyl ether (16HD(D)-DEXA® manufactured by Yokkaichi Chemical Company Ltd.) as (b), and 62 g of isophorone diisocyanate as (c) are placed into a 1-liter four-necked flask equipped with a thermometer, a condenser tube, and a stirrer.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of an unsaturated group-containing urethane acrylate oligomer (A) having a number average molecular weight Mₙ of 21,000 and a degree of unsaturation of 0.25 mol/kg, 47% by weight of acrylic ester monomers (B), and 3% by weight of a photopolymerization initiator (C), based on the total weight of the curable composition.

### Example 5

(i) 340 g of a hydrogenated butadiene oligomer diol (GI-1000® manufactured by Nippon Soda Co., Ltd, number average molecular weight: 1,500) as (a), 14 g of an acrylic acid adduct of propyleneglycol diglycidyl ether (Epoxyester 70PA® manufactured by Kyoeisha Chemical Co., Ltd.) as (b), and 46 g of isophorone diisocyanate as (c) are placed into a 1-liter four-necked flask equipped with a thermometer, a condenser tube, and a stirrer.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of an unsaturated group-containing urethane acrylate oligomer (A) having a number average molecular weight Mₙ of 17,000 and a degree of unsaturation of 0.21 mol/kg, 47% by weight of acrylic ester monomers (B), and 3% by weight of a photopolymerization initiator (C), based on the total weight of the curable composition.

### Example 6

The same procedure as described in Example 1 is carried out, but instead of a mixture of 282 g of isononyl acrylate and 94 g of phenoxyethyl acrylate a mixture of 200 g of nonylphenoxypolyethylene glycol acrylate and 176 g of cyclohexyl acrylate is used as the ingredient (B), with all other conditions remaining the same. Thus, a radiation curable sealing agent composition is obtained, comprising 50% by weight of an unsaturated group-containing urethane acrylate oligomer (A) having a number average molecular weight Mₙ of 17,000 and a degree of unsaturation of 0.21 mol/kg, 47% by weight of acrylic ester monomers (B), and 3% by weight of a photopolymerization initiator (C), based on the total weight of the curable composition.

### Example 7

The same procedure as described in Example 1 is carried out, but instead of a mixture of 282 g of isononyl acrylate and 94 g of phenoxyethyl acrylate a mixture of 300 g of nonylphenoxypolyethylene glycol acrylate and 76 g of isobornyl acrylate is used as the ingredient (B), with all other conditions remaining the same. Thus, a radiation curable sealing agent composition is obtained, comprising 50% by weight of an unsaturated group-containing urethane acrylate oligomer (A) having a number average molecular weight Mₙ of 17,000 and a degree of unsaturation of 0.21 mol/kg, 47% by weight of acrylic ester monomers (B), and 3% by weight of a photopolymerization initiator (C), based on the total weight of the curable composition.

### Example 8

A two-liter planetary mixer is charged with 600 g of the same radiation curable sealing agent composition as prepared in Example 1, and 48 g of a silica powder (“Aerosil 200” available from Nippon Aerosil Co., Ltd.) as the ingredient (D). The content is stirred at 60° C. for approximately 6 hours to give an active energy ray-curable sealing agent composition comprising 100 parts by weight of the sum of the ingredients (A), (B) and (C) and 8 parts by weight of the filler (ingredient (D)).

### Comparative Example 1

In place of the unsaturated group-containing urethane oligomer (A) prepared by reaction of the hydrogenated butadiene oligomer diol (a), the acrylic acid adduct of 1,6-hexanediol diglycidyl ether (b) and isophorone diisocyanate (c) as described in Example 1(i) above, 400 g of a polyether based urethane acrylate oligomer (SHIKOH UV-6640B® manufactured by Nippon Synthetic Chemical Industry Co., Ltd., weight-average molecular weight: 5,000) are placed into a 1-liter four-necked flask equipped with a thermometer, a condenser tube, and a stirrer. To this mixture are added 282 g of isononyl acrylate, 94 g of phenoxyethyl acrylate (B) and 24 g of IRGACURE® 184 (BASF Corporation) as a photo-polymerization initiator (C), and the mixture is stirred for 1 hour at 60° C. until complete dissolution. A radiation curable sealing agent composition is obtained, comprising 50% by weight of an urethane acrylate oligomer, 47% by weight of acrylic ester monomers (B), and 3% by weight of a photopolymerization initiator (C), based on the total weight of the curable composition.

### Comparative Example 2

In place of the unsaturated group-containing urethane oligomer (A) prepared by reaction of the hydrogenated butadiene oligomer diol (a), the acrylic acid adduct of 1,6-hexanediol diglycidyl ether (b) and isophorone diisocyanate (c) as described in Example 1(i) above, 400 g of a polyester diol based urethane acrylate oligomer (SHIKOH® UV-3000B manufactured by Nippon Synthetic Chemical Industry Co., Ltd., weight-average molecular weight: 18,000) are placed into a 1-liter four-necked flask equipped with a thermometer, a condenser tube, and a stirrer. To this mixture 282 g of isononyl acrylate, 94 g of phenoxyethyl acrylate (B) and 24 g of IRGACURE® 184 (BASF Corporation) are added as a photo-polymerization initiator (C), and the mixture is stirred for 1 hour at 60° C. until complete dissolution. A radiation curable sealing agent composition is obtained, comprising 50% by weight of an urethane acrylate oligomer, 47% by weight of acrylic ester monomers (B), and 3% by weight of a photopolymerization initiator (C), based on the total weight of the curable composition.

### Comparative Example 3

(i) 322 g of a polycaprolactone diol (“PCL-220N” manufactured by Daicel Chemical Industries, Ltd.; number average molecular weight: 2,000) as (a) instead of the hydrogenated butadiene oligomer diol polycarbonate diol, 18 g of an acrylic acid adduct of 1,6-hexanediol diglycidyl ether (16HD(D)-DEXA® manufactured by Yokkaichi Chemical Company Ltd.) as (b), and 60 g of isophorone diisocyanate as (c) are placed into a 1-liter four-necked flask equipped with a thermometer, a condenser tube, and a stirrer.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of an unsaturated group-containing urethane acrylate oligomer (A) having a number average molecular weight Mₙ of 20,000 and a degree of unsaturation of 0.24 mol/kg, 47% by weight of acrylic ester monomers (B), and 3% by weight of a photopolymerization initiator (C), based on the total weight of the curable composition.

### Comparative Example 4

(i) 280 g of an acrylic acid adduct of 1,6-hexanediol digycidyl ether as (b) (16HD(D)-DEXA® manufactured by Yokkaichi Chemical Company Ltd.), and 120 g of isophorone diisocyanate as (c) are placed into a 1-liter four-necked flask equipped with a thermometer, a condenser tube, and a stirrer. Hydrogenated butadiene oligomer diol as (a) is not used.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of an unsaturated group-containing urethane acrylate oligomer (A) having a number average molecular weight Mₙ of 4,000 and a degree of unsaturation of 3.8 mol/kg, 47% by weight of acrylic ester monomers (B), and 3% by weight of a photopolymerization initiator (C), based on the total weight of the curable composition.

### Comparative Example 5

(i) 360 g of a hydrogenated butadiene oligomer diol (GI-2000® manufactured by Nippon Soda Co., Ltd, number average molecular weight: 2,000) as (a) and 40 g of isophorone diisocyanate as (c) are placed into a 1-liter four-necked flask equipped with a thermometer, a condenser tube, and a stirrer. A bifunctional epoxy (meth)acrylate having two hydroxyl groups and two ethylenically unsaturated groups in the molecule as (b) is not used.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of urethane resin containing no unsaturated group having a number average molecular weight Mₙ of 20,000 and a degree of unsaturation of 0 mol/kg, 47% by weight of acrylic ester monomers (B), and 3% by weight of a photopolymerization initiator (C), based on the total weight of the curable composition.

### Comparative Example 6

(i) 325 g of a hydrogenated butadiene oligomer diol (GI-2000® manufactured by Nippon Soda Co., Ltd, number average molecular weight: 2,000) as (a), 25 g of acrylic acid adduct of gycidyl methacrylate (“NK Ester 701A” available from Shin-Nakamura Chemical Co., Ltd.) instead of the ingredient (b), and 50 g of isophorone diisocyanate as (c) are placed into a 1-liter four-necked flask equipped with a thermometer, a condenser tube, and a stirrer.

(ii) To this mixture 282 g of isononyl acrylate and 94 g of phenoxyethyl acrylate (B) are added as a diluent and the reaction mixture is stirred at 70° C. for about 48 hours. Completion of the reaction is verified by infrared spectroscopy (disappearance of the isocyanate absorption signal). To the resulting reaction mixture, 24 g of IRGACURE® 184 (BASF Corporation) are added as a photopolymerization initiator (C), and the mixture is stirred for 30 minutes to dissolve the initiator. A radiation curable sealing agent composition is obtained, comprising 50% by weight of urethane resin containing no unsaturated group having a number average molecular weight Mₙ of 15,000 and a degree of unsaturation of 0.56 mol/kg, 47% by weight of acrylic ester monomers (B), and 3% by weight of a photopolymerization initiator (C), based on the total weight of the curable composition.

### Application Example

A metal sheet for dust cover provided in a magnetic hard disc drive device, having a size of 102 mm×146 mm, is degreased and a gasket is formed on the periphery of the metal sheet by placing the radiation curable sealing agent composition prepared in any one of Examples 1 to 8 (or Comparative Examples 1 to 6) on the periphery of the metal sheet 4 through a dispenser 3 by means of a robot applicator as illustrated in FIG. 1. The composition for gasket is irradiated with ultraviolet rays at a dose of 2,000 mJ/cm² to give a dust cover with the gasket 5 of cured sealing agent composition as illustrated in FIG. 2. The gasket 5, formed on the periphery of the metal sheet 4 as illustrated in FIG. 2, has a width of 2 mm (in which the gasket is in contact with the metal sheet) and a height of 1 mm from the surface of metal sheet 4. The sealing agent composition for gasket is cured by the irradiation with ultraviolet rays, and the gasket has a cross-section with an approximately half circle shape. The gasket is fixedly set at a predetermined position simultaneously with shaping.

TABLE 1
Evaluation results

| | Examples | | | | | | | |
|---|---|---|---|---|---|---|---|---|
| | 1 | 2 | 3 | 4 | 5 | 6 | 7 | 8 |
| Reactivity | A | A | A | A | A | A | A | A |
| Hardness | A | A | A | A | A | A | A | A |
| (Shore A) | (33) | (32) | (32) | (29) | (34) | (34) | (35) | (38) |
| Tensile strength | A | A | A | A | A | A | A | A |
| (MPa) | (9.5) | (9.0) | (9.2) | (8.7) | (9.6) | (9.8) | (10.3) | (11.6) |
| Elongation (%) | A | A | A | A | A | A | A | A |
| | (210) | (230) | (230) | (250) | (220) | (210) | (240) | (210) |
| Tear strength | A | A | A | A | A | A | A | A |
| (N/mm) | (10.7) | (10.5) | (9.8) | (8.7) | (9.5) | (9.9) | (10.3) | (11.4) |
| Air-tightness | A | A | A | A | A | A | A | A |
| Durability | A | A | A | A | A | A | A | A |
| MVTR | A | A | A | A | A | A | A | A |
| (g/m² 24 h) | (1.1) | (1.2) | (1.4) | (1.9) | (1.3) | (1.4) | (1.1) | (1.2) |

TABLE 2
Evaluation results

| | Comparative Examples | | | | | |
|---|---|---|---|---|---|---|
| | 1 | 2 | 3 | 4 | 5 | 6 |
| Reactivity | A | M | A | A | *NC | A |
| Hardness | U | A | A | U | — | U |
| (Shore A) | (60) | (35) | (30) | (75) | | (52) |
| Tensile strength | — | U | U | — | — | — |
| (MPa) | | (2.8) | (2.3) | | | |
| Elongation (%) | U | A | A | U | — | U |
| | (20) | (200) | (220) | (12) | | (120) |
| Tear strength | — | U | U | — | — | — |
| (N/mm) | | (4.9) | (3.4) | | | |
| Air-tightness | U | A | A | U | — | U |
| Durability | — | U | U | — | — | — |
| MVTR | U | U | U | U | — | A |
| (g/m² · 24 h) | (9.6) | (22.6) | (32.5) | (18.9) | | (3.6) |

*NC: not cured

1. An active energy ray-curable sealing agent composition, comprising
(A) at least one unsaturated group-containing urethane oligomer having a number average molecular weight Mn of from 1,000 to 100,000 and a degree of unsaturation of from 0.1 to 1 mol/kg obtained by reacting
at least one hydrogenated diene-based oligomer diol (a) having a number average molecular weight Mn of from 500 to 3,000,
at least one bifunctional epoxy (meth)acrylate (b) containing two hydroxyl groups and two ethylenically unsaturated groups in the molecule thereof, and
at least one polyisocyanate (c);
(B) at least one (meth)acrylic ester monomer obtained by esterification of (meth)acrylic acid or a (meth)acrylic acid derivative with an alcohol of the formula R—OH, wherein R corresponds to an organic radical containing 1 to 20 carbon atoms and having a molecular weight of 1,000 or less; and
(C) at least one photopolymerization initiator.

2. The active energy ray-curable sealing agent composition according to claim 1, wherein the hydrogenated diene-based oligomer diol (a) is a hydrogenated oligomer with terminal hydroxyl groups or a mixture of hydrogenated oligomers with terminal hydroxyl groups comprising homopolymeric or copolymeric oligomers prepared from at least one compound selected from the group 1,3-butadiene, isoprene, 2,3-dimethyl-1,3-butadiene, 1,3-pentadiene (piperylene), 2-methyl-3-ethyl-1,3-butadiene, 3-methyl-1,3-pentadiene, 1,3-hexadiene, 2-methyl-1,3-hexadiene and 3-buthyl-1,3-octadiene.

3. The active energy ray-curable sealing agent composition according to claim 1, wherein the hydrogenated diene-based oligomer diol (a) is a hydrogenated oligomer with terminal hydroxyl groups or a mixture of hydrogenated oligomers with terminal hydroxyl groups comprising homopolymeric or copolymeric oligomers prepared from at least one compound selected from the group 1,3-butadiene and isoprene.

4. The active energy ray-curable sealing agent composition according to claim 1, wherein the bifunctional epoxy (meth)acrylate (b) corresponds to formula (b-1) or formula (b-2), (b-1), (b-2), in which B independently is an aliphatic or aromatic bridge member.

5. The active energy ray-curable sealing agent composition according to claim 4, wherein B is a C2-C12 alkylene radical, in particular a C2-C8 alkylene radical.

6. The active energy ray-curable sealing agent composition according to claim 1, wherein the polyisocyanate (c) is an aliphatic diisocyanate, an alicyclic disocyanate or an aromatic diisocyanate compound, in particular isophorone diisocyanate.

7. The active energy ray-curable sealing agent composition according to claim 1, wherein the amount of (a) is 60 to 90% by weight, the amount of (b) is 2.5 to 15% by weight, and the amount of (c) is 5 to 25% by weight, each based on the total weight of (a), (b) and (c).

8. The active energy ray-curable sealing agent composition according to claim 1, wherein the (meth)acylic ester monomer (B) is a monofunctional (meth)acrylic acid ester monomer having one (meth)acryloyl group.

9. A unit provided with a sealing layer, which is prepared by applying to the unit the active energy ray-curable sealing agent composition according to claim 1, and then, irradiating the thus-applied sealing agent composition with active energy rays thereby curing the said sealing agent composition.

10. The unit provided with a sealing layer according to claim 9, which unit is a body housing for encasing high precision electronic instruments, in particular, magnetic hard disc drive apparatuses or electronic control devices in an automobile.

11. An unsaturated group-containing urethane resin (A) having a number average molecular weight Mn of from 1,000 to 100,000 and a degree of unsaturation of from 0.1 to 1 mol/kg obtained by reacting at least one hydrogenated diene-based oligomer diol (a) having a number average molecular weight Mn of from 500 to 3,000, at least one bifunctional epoxy (meth)acrylate (b) containing two hydroxyl groups and two ethylenically unsaturated groups in the molecule thereof, and at least one polyisocyanate (c).
